(19) United States
(12) Patent Application Publication
(10) Pub. No.: US 2023/0081857 A1
(43) Pub. Date: Mar. 16, 2023

(54) SPEED REDUCER-EQUIPPED MOTOR

(71) Applicant: DENSO CORPORATION, Kariya-city (JP)

(72) Inventors: Masahito SAKAI, Kariya-city (JP); Kazuki MARUO, Kariya-city (JP)

(73) Assignee: DENSO CORPORATION, Kariya-city (JP)

(21) Appl. No.: 17/990,975

(22) Filed: Nov. 21, 2022

Related U.S. Application Data
(63) Continuation of application No. PCT/JP2021/009010, filed on Mar. 8, 2021.

(30) Foreign Application Priority Data
May 22, 2020 (JP) 2020-089771

(51) Int. Cl. H02K 7/116; F16H 1/32

(52) U.S. Cl. CPC H02K 7/116; F16H 1/32

(57) ABSTRACT

A speed reducer-equipped motor of the present disclosure includes a housing to which a motor is fixed and that has a speed reducer housing recess, and a helical gear and a locking gear that are accommodated in the speed reducer housing recess. A spring is provided between the helical gear and the locking gear, and reduces wobbling of the helical gear, the locking gear, and the like in the speed reducer housing recess.

### CROSS-REFERENCE TO RELATED APPLICATION

The present application is a continuation application of International Application No. PCT/JP2021/009010, filed on Mar. 8, 2021, which claims priority to Japanese Patent Application No. 2020-089771, filed in Japan on May 22, 2020. The contents of these applications are incorporated herein by reference in their entirety.

### BACKGROUND

### 1. Technical Field

The present disclosure relates to a speed reducer-equipped motor.

### 2. Related Art

A speed reducer-equipped motor adjusts the position of a seat cushion of a vehicle seat in a vertical direction. The speed reducer-equipped motor includes a base, a motor fixed to the base, and a plurality of speed reducer components such as a gear that are accommodated in the base and that reduce a rotation speed of the motor and transmit the rotation to a pinion which is an output shaft. Furthermore, the speed reducer-equipped motor includes a spring washer for reducing wobbling of the speed reducer components in the base.

### SUMMARY

The present disclosure provides a speed reducer-equipped motor. As one aspect of the present disclosure, a speed reducer-equipped motor includes at least a housing, a helical gear, an elastic member, and a second portion. The housing is fixed to a motor and has a speed reducer housing portion. The helical gear is accommodated in the speed reducer housing portion and constitutes a first portion of a speed reducer component for reducing a rotation speed of the motor. The tooth trace of the helical gear as viewed from a rotation radial direction has a helix shape in a rotation axial direction. The second portion of the speed reducer component is accommodated in the speed reducer housing portion. The elastic member is disposed between the helical gear and the second portion of the speed reducer component and biases the second portion of the speed reducer component toward a side opposite to the helical gear to reduce wobbling of the speed reducer component in the speed reducer housing portion.

### BRIEF DESCRIPTION OF THE DRAWINGS

In the accompanying drawings:

FIG. 1 is an exploded perspective view showing a speed reducer-equipped motor;

FIG. 2 is an exploded perspective view showing the speed reducer-equipped motor as viewed from a side opposite to the side from which the speed reducer-equipped motor is viewed in FIG. 1;

FIG. 3 is an enlarged exploded perspective view showing an eccentric shaft, a helical gear, a spring, a locking gear, and a fixed gear constituting a part of the speed reducer;

FIG. 4 is an enlarged exploded perspective view showing the eccentric shaft, the helical gear, the spring, the locking gear, and the fixed gear constituting a part of the speed reducer as viewed from a side opposite to the side from which the components are viewed in FIG. 3;

FIG. 5 is an enlarged perspective view showing the eccentric shaft, the helical gear, the locking gear, the fixed gear, and a slider plate constituting a part of the speed reducer;

FIG. 6 is a plan view of the speed reducer-equipped motor as viewed from a pinion gear side; and

FIG. 7 is a cross-sectional view showing a cross section of the speed reducer-equipped motor taken along line 7-7 shown in FIG. 6.

### DETAILED DESCRIPTION OF THE PREFERRED EMBODIMENTS

In the speed reducer-equipped motor described in U.S. Pat. No. 8,936,526 B (hereinafter referred to as “Patent Literature 1”), the spring washer is provided between the base and a ring gear which is a helical gear. Thus, when a load of the spring washer is set, a force in a thrust direction acting on the ring gear needs to be considered in order to reduce wobbling of a speed reducer component disposed on a side opposite to the spring washer with respect to the ring gear. Specifically, the load of the spring washer needs to be set to exceed a force in the thrust direction input from the ring gear to the spring washer. This makes it difficult for the configuration of the speed reducer-equipped motor described in Patent Literature 1 to reduce a load of an elastic member such as a spring washer for reducing wobbling of a speed reducer component.

In view of the above fact, an object of the present disclosure is to provide a speed reducer-equipped motor capable of reducing a load of an elastic member for reducing wobbling of a speed reducer component.

A speed reducer-equipped motor of a first aspect of the present disclosure includes a housing to which a motor is fixed and that has a speed reducer housing portion, a helical gear that is accommodated in the speed reducer housing portion and constitutes a first portion of a speed reducer component for reducing a rotation speed of the motor and whose tooth trace as viewed from a rotation radial direction has a helix shape in a rotation axial direction, a second portion of the speed reducer component that is accommodated in the speed reducer housing portion, and an elastic member that is disposed between the helical gear and the second portion of the speed reducer component and that biases the second portion of the speed reducer component toward a side opposite to the helical gear to reduce wobbling of the speed reducer component in the speed reducer housing portion.

This configuration can reduce a load of the elastic member for reducing wobbling of the speed reducer component.

The above object and other objects, features, and advantages of the present disclosure will become more apparent from the following detailed description with reference to the accompanying drawings.

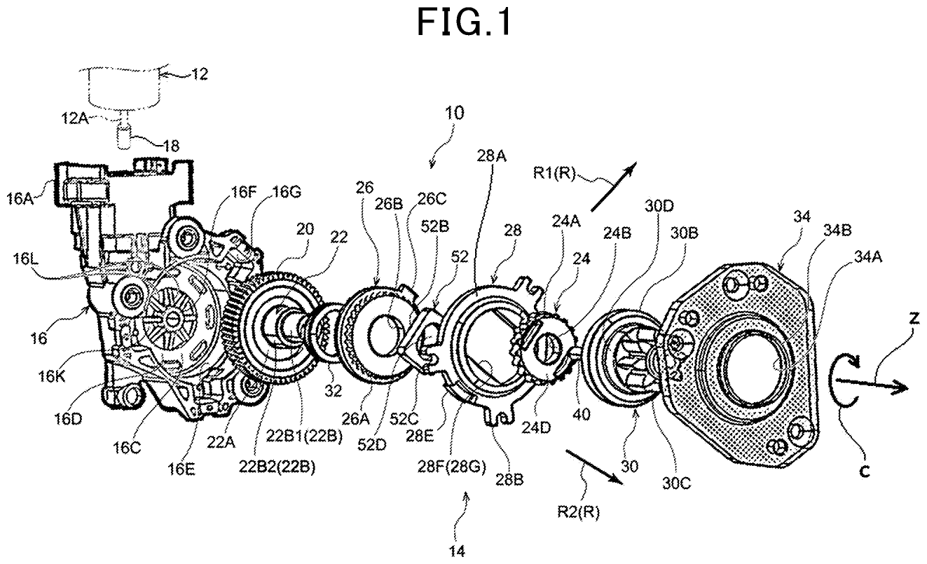

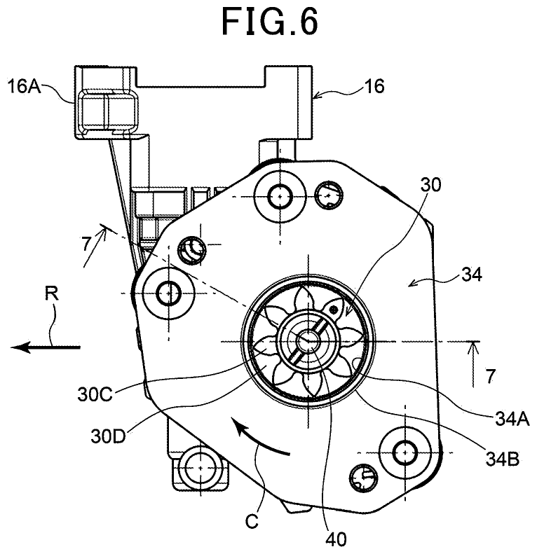

A speed reducer-equipped motor 10 according to an embodiment of the present disclosure will be described with reference to FIGS. 1 to 7. A direction of an arrow Z, a direction of an arrow R, and a direction of an arrow C shown as appropriate in the drawings respectively indicate a direction of a first side of a pinion gear 30C as an output gear in a rotation axial direction, a direction of an outer side of the pinion gear 30C in a rotation radial direction, and a direction of a first side of the pinion gear 30C in a rotation circumferential direction. A direction opposite to the direction of the arrow Z, a direction opposite to the direction of the arrow R, and a direction opposite to the direction of the arrow C respectively indicate a direction of a second side of the pinion gear 30C as an output gear in the rotation axial direction, a direction of an inner side of the pinion gear 30C in the rotation radial direction, and a direction of a second side of the pinion gear 30C in the rotation circumferential direction. Furthermore, directions simply described as an axial direction, a radial direction, and a circumferential direction respectively indicate the rotation axial direction, rotation radial direction, and rotation circumferential direction of the pinion gear 30C unless otherwise specified.

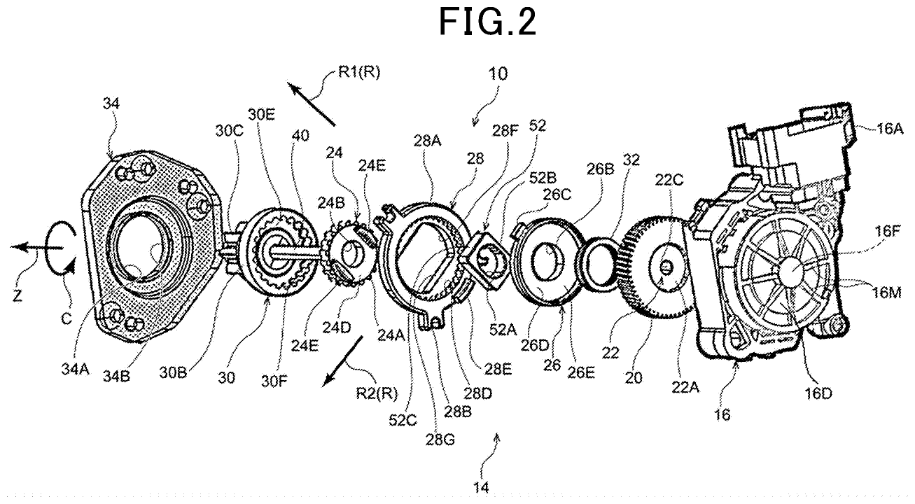

As shown in FIGS. 1 and 2, the speed reducer-equipped motor 10 of the present embodiment is a power seat motor for moving a seat cushion of a vehicle seat in a vertical direction of the seat. The speed reducer-equipped motor 10 includes a motor 12 which is a DC motor. Furthermore, the speed reducer-equipped motor 10 includes a speed reducer 14 for reducing a rotation speed of a rotating shaft 12A of the motor 12 and transmitting the rotation to an output gear body 30 as an output unit. Furthermore, the speed reducer-equipped motor 10 includes a housing 16 to which the motor 12 is attached and in which the speed reducer 14 is provided.

The speed reducer 14 includes a worm gear 18 that is fixed to the rotating shaft 12A of the motor 12, a helical gear 20 that is engaged with the worm gear 18, and an eccentric shaft 22 that is integrated with the helical gear 20.

The speed reducer 14 includes a transmitting gear 24 and a locking gear 26 that are supported by the eccentric shaft 22, and a fixed gear 28 that is engaged with the locking gear 26. Furthermore, the speed reducer 14 includes a slider plate 52 that is supported by the fixed gear 28 and that is engaged with the transmitting gear 24 to limit the rotation of the transmitting gear 24 on its axis. Furthermore, the speed reducer 14 includes the output gear body 30 that is engaged with the transmitting gear 24 and that has the pinion gear 30C. The output gear body 30 is coaxially disposed with the helical gear 20, and an axial direction of the output gear body 30 is parallel to an axial direction of the transmitting gear 24 and the locking gear 26.

The speed reducer-equipped motor 10 includes a cover member 34 that is fixed to the housing 16 to cause the speed reducer 14 to be accommodated in the housing 16. Furthermore, the speed reducer-equipped motor 10 includes a spring 32 for reducing wobbling of speed reducer components constituting the speed reducer 14 in the housing 16.

As shown in FIGS. 1 and 2, the housing 16 is made of a resin material. The housing 16 has a motor fixing portion 16A to which the motor 12 is fixed while the rotating shaft 12A of the motor 12 is oriented in a direction perpendicular to the axial direction (the direction of the arrow Z). Furthermore, the housing 16 has a speed reducer housing recess 16C as a speed reducer housing portion in which the speed reducer 14 is accommodated. The speed reducer housing recess 16C has a recessed shape that is open on the first side in the axial direction (the side of the direction of the arrow Z).

As shown in FIG. 1, the speed reducer housing recess 16C has a bottom wall portion 16D that constitutes a bottom of the speed reducer housing recess 16C, and a side wall portion 16E that extends from an outer peripheral portion of the bottom wall portion 16D toward the first side in the axial direction and whose inner peripheral surface is a substantially cylindrical surface. A boss portion 16F having a cylindrical shape is provided in a center portion of the bottom wall portion 16D of the speed reducer housing recess 16C. An end portion of a rotation center shaft 40 (described later) on the second side in the axial direction is inserted with a clearance in the boss portion 16F and supported by the boss portion 16F. A recessed portion 16K that is open on the first side in the axial direction is provided around the boss portion 16F of the bottom wall portion 16D. A plurality of ribs 16L having a plate shape are provided in the recessed portion 16K. The plurality of ribs 16L are integrated with the bottom wall portion 16D which is a bottom of the boss portion 16F and the recessed portion 16K. The plurality of ribs 16L are arranged at equal intervals in the circumferential direction around the boss portion 16F. As shown in FIG. 2, a plurality of ribs 16M corresponding to the plurality of ribs 16L are provided in a portion of the bottom wall portion 16D of the housing 16 on an outer side of the speed reducer housing recess 16C.

As shown in FIG. 1, an inner peripheral portion of the side wall portion 16E of the speed reducer housing recess 16C has three fixed gear engagement portions 16G that are engaged with a part of the fixed gear 28 (described later) to restrict rotational displacement of the fixed gear 28 in the circumferential direction.

As shown in FIGS. 1, 6, and 7, the cover member 34 is made of, for example, a resin material or the like. The cover member 34 has an exposure opening 34A for exposing the pinion gear 30C to the outside of the speed reducer housing recess 16C of the housing 16. A peripheral edge portion of the exposure opening 34A of the cover member 34 has an annular rib 34B that is bent toward the second side in the axial direction.

An outer peripheral portion of the worm gear 18 has a spiral-shaped tooth portion. The motor 12 in which the worm gear 18 is fixed to the rotating shaft 12A is fixed to the housing 16 to cause the worm gear 18 to be disposed in a portion of the housing 16 on the bottom wall portion side of the speed reducer housing recess 16C and the inner peripheral surface side of the side wall portion 16E.

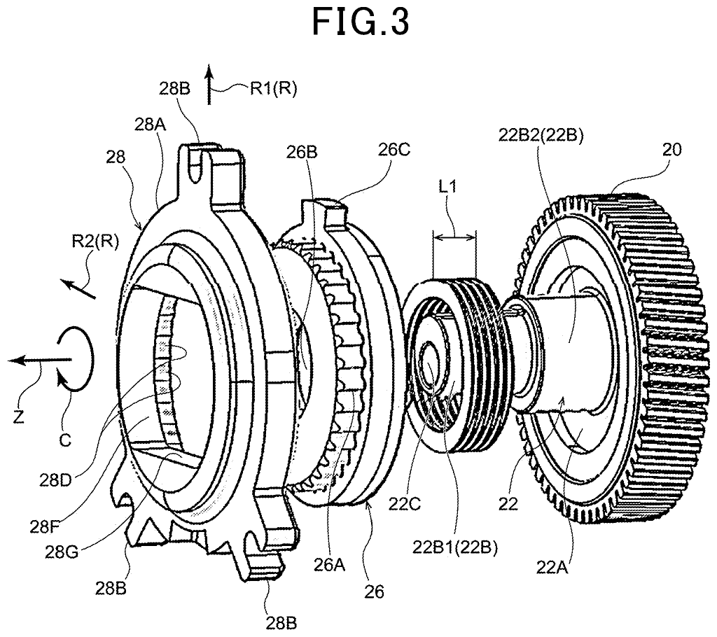

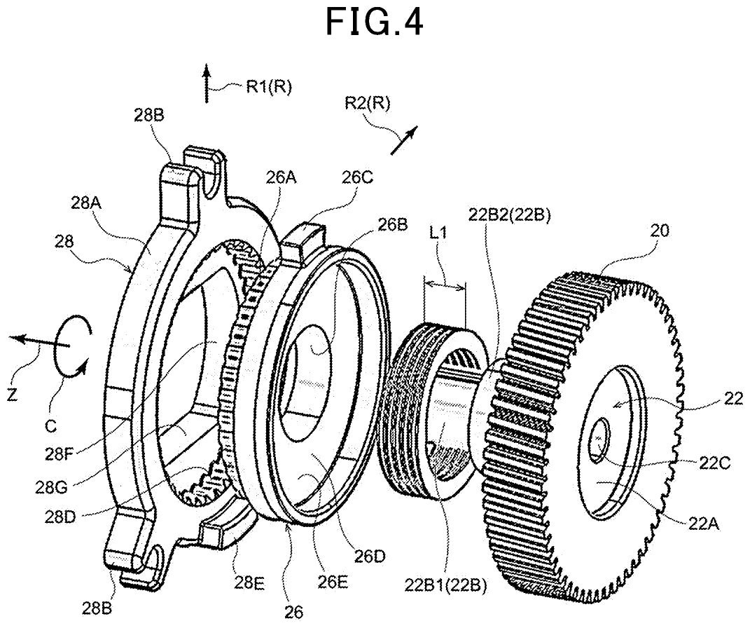

As shown in FIGS. 3 and 4, the helical gear 20 as a speed reducer component is made of a resin material. An outer peripheral portion of the helical gear 20 has a plurality of external teeth that are engaged with the tooth portion of the worm gear 18. A tooth trace of the external teeth as viewed from the outer side of the external teeth in the radial direction has a helix shape in the axial direction. The eccentric shaft 22 (described later) is fixed to an axial center portion of the helical gear 20 by insert molding. That is, a part of the eccentric shaft 22 is embedded in the axial center portion of the helical gear 20. The helical gear 20 is rotatably supported by the housing 16 via the eccentric shaft 22 and the rotation center shaft 40.

The eccentric shaft 22 as a speed reducer component is made of a metal material, and is partially inserted in the helical gear 20 to be rotatable integrally with the helical gear 20. Specifically, the eccentric shaft 22 has a disk portion 22A having a disk shape. A thickness direction of the disk portion 22A is the axial direction, and the disk portion 22A extends in the radial direction. An outer peripheral portion of the disk portion 22A has a recessed and projected shape extending in the circumferential direction. The outer peripheral portion of the disk portion 22A is embedded in an inner peripheral portion of the helical gear 20 while an axial center of the disk portion 22A coincides with a rotation center of the helical gear 20.

The eccentric shaft 22 has a support portion 22B that protrudes from a center portion of the disk portion 22A toward the first side in the axial direction. A first support portion 22B1 is a portion of the support portion 22B on the first side in the axial direction. The first support portion 22B1 rotatably supports the transmitting gear 24 (described later). A second support portion 22B2 is a portion of the support portion 22B on the second side in the axial direction. The second support portion 22B2 is set to have a larger diameter than the first support portion 22B1, and rotatably supports the locking gear 26 (described later). An axial center of the first support portion 22B1 and the second support portion 22B2 is offset with respect to the axial center of the disk portion 22A in a direction toward the outer side in the radial direction.

The eccentric shaft 22 has a rotation center shaft insertion hole 22C that passes through the disk portion 22A, the first support portion 22B1, and the second support portion 22B2 in the axial direction and through which the rotation center shaft 40 (see FIG. 2) is inserted. An axial center of the rotation center shaft insertion hole 22C, that is, an axial center of the rotation center shaft 40 inserted through the rotation center shaft insertion hole 22C, coincides with the axial center of the disk portion 22A.

As shown in FIGS. 1 and 2, the output gear body 30 as a speed reducer component is made of a metal material. The output gear body 30 has a transmitting gear engagement portion 30B that is engaged with the transmitting gear 24. As shown in FIG. 2, the transmitting gear engagement portion 30B has a housing recess 30E that is open on the transmitting gear 24 side (the second side in the axial direction) and in which a transmitting gear body 24D of the transmitting gear 24 is disposed. An inner peripheral portion of the housing recess 30E on the outer side in the radial direction has a plurality of internal teeth 30F that are engaged with external teeth 24A of the transmitting gear 24.

As shown in FIGS. 1 and 2, the output gear body 30 has the pinion gear 30C that is coaxially disposed with the transmitting gear engagement portion 30B on the first side in the axial direction with respect to the transmitting gear engagement portion 30B and whose outer peripheral portion has a plurality of external teeth. The output gear body 30 has an axially supported portion 30D that is an intermediate portion of the output gear body 30 between the transmitting gear engagement portion 30B and the pinion gear 30C and that is axially supported by the rib 34B of the cover member 34. The rotation center shaft 40 that is made of a metal material and has a bar shape is fixed to an axial center portion of the output gear body 30 by press fitting or the like.

As shown in FIGS. 3 and 4, the fixed gear 28 as a speed reducer component is formed, for example, by pressing a metal material. The fixed gear 28 has a fixed gear body 28A that has an annular shape as viewed in the axial direction. Furthermore, the fixed gear 28 has three engagement protrusions 28B that protrude from the fixed gear body 28A toward the outer side in the radial direction. As shown in FIG. 1, the fixed gear 28 is fixed to the housing 16 while the engagement protrusions 28B are engaged with the fixed gear engagement portions 16G of the housing 16.

As shown in FIG. 4, an inner peripheral portion of the fixed gear body 28A has a plurality of internal teeth 28D that are engaged with the locking gear 26 (described later).

Furthermore, the fixed gear 28 has a second regulating portion 28E that protrudes from the fixed gear body 28A toward the second side in the axial direction. The second regulating portion 28E protrudes from a portion of the fixed gear body 28A in the circumferential direction toward the second side in the axial direction.

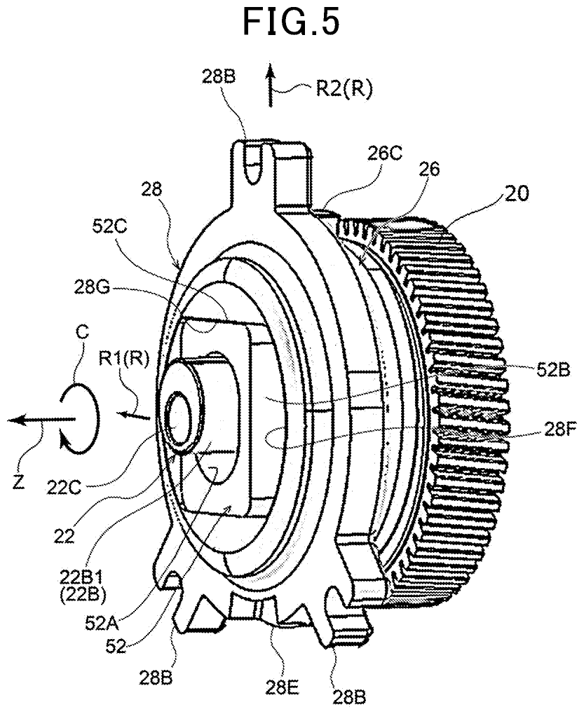

As shown in FIGS. 4 and 5, a slider plate engagement hole 28F is provided in an axial core portion on the first side in the axial direction of a portion of the fixed gear body 28A of the fixed gear 28 that has the internal teeth 28D. An edge portion of the slider plate engagement hole 28F has a rectangular shape (rectangle shape) as viewed in the axial direction, and the slider plate 52 is disposed in the slider plate engagement hole 28F. The edge portion of the slider plate engagement hole 28F has second slider surfaces 28G that are arranged to face a respective pair of first slider surfaces 52C of the slider plate 52 (described later) in the radial direction. The first slider surfaces 52C are arranged to face the second slider surfaces 28G and arranged proximate to the second slider surfaces 28G to limit the rotation of the slider plate 52 relative to the fixed gear 28. Furthermore, the first slider surfaces 52C slide on the second slider surfaces 28G to allow displacement of the slider plate 52 and the transmitting gear 24 in a first radial direction R1. Thus, in response to rotation of the eccentric shaft 22, the transmitting gear 24 revolves around the axial center of the rotation center shaft 40 while the rotation on its axis of the transmitting gear 24 supported by the first support portion 22B1 of the eccentric shaft 22 is limited.

As shown in FIGS. 1 and 2, the transmitting gear 24 as a speed reducer component is formed to have a substantially disk shape, for example, by pressing a metal material. The transmitting gear 24 has the transmitting gear body 24D whose outer peripheral portion has the plurality of external teeth 24A. A center portion of the transmitting gear body 24D has a support hole 24B through which the transmitting gear 24 is supported by the first support portion 22B1 of the eccentric shaft 22. Furthermore, the transmitting gear 24 has two limiting protrusions 24E that protrude from a surface of the transmitting gear body 24D on the second side in the axial direction toward the second side in the axial direction. The two limiting protrusions 24E are arranged at equal intervals (at a pitch of 180 degrees) in the circumferential direction. The two limiting protrusions 24E are engaged with the slider plate 52 (described later) to limit the rotation (rotation on its axis) of the transmitting gear 24 around the first support portion 22B1 of the eccentric shaft 22.

As shown in FIGS. 1, 2, and 5, the slider plate 52 as a speed reducer component is made of a metal plate, and has a rectangular shape (rectangle shape) as viewed in the axial direction. The slider plate 52 is disposed between the two limiting protrusions 24E of the transmitting gear 24 in the slider plate engagement hole 28F of the fixed gear 28. An outer peripheral portion of the slider plate 52 has engagement surfaces 52B that are arranged to face the respective two limiting protrusions 24E in the radial direction. The slider plate 52 disposed between the two limiting protrusions 24E of the transmitting gear 24 limits the displacement of the transmitting gear 24 relative to the slider plate 52 in a direction in which the engagement surfaces 52B and the limiting protrusions 24E face each other (first radial direction R1), and limits the rotation (rotation on its axis) of the transmitting gear 24 relative to the slider plate 52. Furthermore, the limiting protrusions 24E slide on the engagement surfaces 52B to allow displacement of the transmitting gear 24 relative to the slider plate 52 in a direction in which the engagement surfaces 52B and the limiting protrusions 24E slide (second radial direction R2 perpendicular to the first radial direction R1). The outer peripheral portion of the slider plate 52 has the pair of first slider surfaces 52C that are arranged to face the respective second slider surfaces 28G of the slider plate engagement hole 28F and arranged proximate to the respective second slider surfaces 28G. An axial core portion of the slider plate 52 has an insertion hole 52A having a long-hole shape (a long-hole shape whose longitudinal direction is the second radial direction R2). The first support portion 22B1 of the eccentric shaft 22 is inserted through the insertion hole 52A. In the present embodiment, a distance between the pair of engagement surfaces 52B of the slider plate 52 is set to be smaller than a distance between the pair of first slider surfaces 52C. Thus, the slider plate 52 has a rectangular shape whose long sides are constituted by the pair of engagement surfaces 52B and whose short sides are constituted by the pair of first slider surfaces 52C as viewed in the axial direction.

As shown in FIGS. 3 and 4, the locking gear 26 as a speed reducer component is formed to have a disk shape, for example, by pressing a metal material, as with the transmitting gear 24. An outer peripheral portion of the locking gear 26 has external teeth 26A that are provided along the entire circumference of the outer peripheral portion of the locking gear 26 and engaged with the internal teeth 28D of the fixed gear 28. A center portion of the locking gear 26 has a support hole 26B through which the locking gear 26 is supported by the second support portion 22B2 of the eccentric shaft 22. Furthermore, the locking gear 26 has a first regulating portion 26C that protrudes toward the outer side in the radial direction and that has a fan shape as viewed in the axial direction. The first regulating portion 26C is provided in a portion of the locking gear 26 in the circumferential direction. The first regulating portion 26C is disposed along a surface of the fixed gear body 28A of the fixed gear 28 on the second side in the axial direction while the external teeth 26A of the locking gear 26 are engaged with the internal teeth 28D of the fixed gear 28. As shown in FIG. 4, a recessed portion 26D that is open on the second side in the axial direction is provided in a portion of the locking gear 26 on the second side in the axial direction. A part of the spring 32 (described later) is disposed on the inner side of the recessed portion 26D in the radial direction. A spring contact surface 26E that extends in the radial direction in a plane is a bottom of the recessed portion 26D which is a surface of the locking gear 26 that faces the spring 32 (described later) in the axial direction.

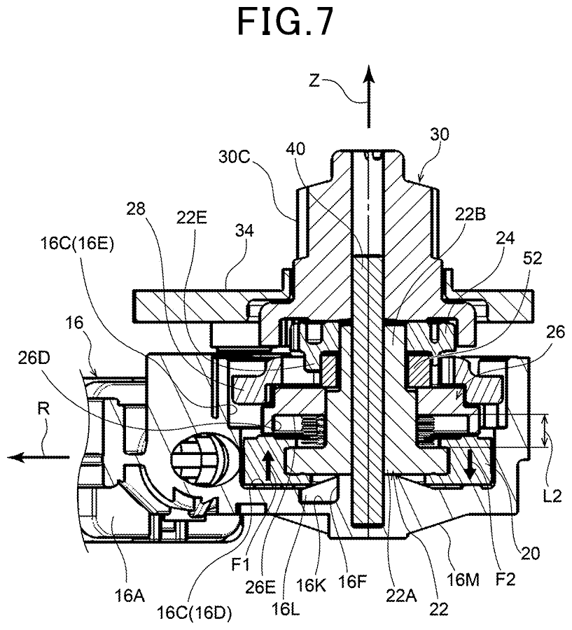

As shown in FIGS. 3 and 4, the spring 32 as an elastic member is provided between the helical gear 20 and the locking gear 26. The spring 32 is an annular compression coil spring having a natural length L1 and a spring constant K. As shown in FIG. 7, the spring 32 inserted in the support portion 22B of the eccentric shaft 22 is assembled in a process of assembling the speed reducer-equipped motor 10. While the cover member 34 is fixed to the housing, the spring 32 is compressed between a surface of the disk portion 22A of the eccentric shaft 22 on the first side in the axial direction and the spring contact surface 26E of the locking gear 26 so that the length of the spring 32 is reduced from the natural length L1 to a set length L2. This causes the spring 32 to bias the helical gear 20 and the eccentric shaft 22 toward the second side in the axial direction and to bias the locking gear 26 toward the first side in the axial direction. While the cover member 34 is fixed to the housing and the rotating shaft 12A of the motor 12 is not rotated, the disk portion 22A of the eccentric shaft 22 is in contact with the boss portion 16F of the housing 16, limiting the movement of the eccentric shaft 22 and the helical gear 20 toward the second side in the axial direction. The helical gear 20 is separated from the bottom wall portion 16D of the housing 16 in the axial direction while the disk portion 22A of the eccentric shaft 22 is in contact with the boss portion 16F of the housing 16.

As in the speed reducer-equipped motor 10 of the present embodiment shown in FIG. 1, in the configuration in which the worm gear 18 fixed to the rotating shaft 12A of the motor 12 is engaged with the helical gear 20, as shown in FIG. 7, in the case where the rotating shaft 12A of the motor 12 is rotated toward the first side, a thrust force F1 toward the first side in the axial direction is generated in the helical gear 20. On the other hand, in the case where the rotating shaft 12A of the motor 12 is rotated toward the second side, a thrust force F2 toward the second side in the axial direction is generated in the helical gear 20. Therefore, in the case where the thrust force F1 toward the first side in the axial direction is generated in the helical gear 20, the helical gear 20 is moved together with the eccentric shaft 22 toward the first side in the axial direction; thus, the spring 32 is further compressed so that the length of the spring 32 is reduced from the set length L2. In the case where the thrust force F2 toward the second side in the axial direction is generated in the helical gear 20, the boss portion 16F of the housing 16 limits the movement of the helical gear 20 and the eccentric shaft 22 toward the second side in the axial direction; thus, the length of the spring 32 is unchanged from the set length L2.

### (Operations and Effects of the Present Embodiment)

Next, operations and effects of the present embodiment will be described.

As shown in FIGS. 1, 2, 3, 4, and 7, in the speed reducer-equipped motor 10 of the present embodiment, in response to rotation of the rotating shaft 12A of the motor 12, the worm gear 18 is rotated. In response to the rotation of the worm gear 18, the helical gear 20 engaged with the worm gear 18 is rotated together with the eccentric shaft 22.

Furthermore, in response to the rotation of the eccentric shaft 22, the transmitting gear 24 supported by the first support portion 22B1 of the eccentric shaft 22 is revolved around the rotation center shaft 40. Specifically, in response to the rotation of the eccentric shaft 22, the limiting protrusions 24E of the transmitting gear 24 are moved in the radial direction (the direction of the arrow R2 and the direction opposite to the direction of the arrow R2) while the limiting protrusions 24E are sliding on the engagement surfaces 52B of the slider plate 52. Furthermore, the slider plate 52 and the transmitting gear 24 are moved in the radial direction (the direction of the arrow R1 and the direction opposite to the direction of the arrow R1) while the first slider surfaces 52C of the slider plate 52 are sliding on the second slider surfaces 28G of the fixed gear 28. Thus, the transmitting gear 24 revolves around the axial center of the rotation center shaft 40 while the rotation on its axis of the transmitting gear 24 supported by the first support portion 22B1 of the eccentric shaft 22 is limited.

In response to the revolution of the transmitting gear 24, a rotational force generated by the revolution is transmitted from the external teeth 24A of the transmitting gear 24 to the output gear body 30 via the internal teeth 30F of the output gear body 30. This causes rotation of the output gear body 30, allowing operation of the vehicle power seat via the gear engaged with the pinion gear 30C of the output gear body 30.

Furthermore, in response to the rotation of the eccentric shaft 22, the locking gear 26 supported by the second support portion 22B2 of the eccentric shaft 22 rotates on its axis and revolves around the rotation center shaft 40 while the locking gear 26 is engaged with the fixed gear 28. When the first regulating portion 26C of the locking gear 26 is brought into contact with the second regulating portion 28E of the fixed gear 28, the rotation of the locking gear 26 on its axis and the revolution of the locking gear 26 are restricted. This stops the rotation of the eccentric shaft 22 and the helical gear 20, thus stopping the rotation of the rotating shaft 12A of the motor 12 and the output gear body 30. This prevents or reduces input of an excessive force from the speed reducer-equipped motor 10 to the vehicle seat, thus preventing or reducing deterioration in sitting comfort, for example, due to deformation of a component of the vehicle seat.

In the present embodiment, the spring 32 is provided between the helical gear 20 and the locking gear 26; thus, the length of the spring 32 does not exceed the set length L2 irrespective of the direction of the thrust forces F1 and F2 generated in the helical gear 20. Therefore, in the present embodiment, the spring 32 only needs to be set so that a load of the spring when the length of the spring 32 is the set length L2 is the minimum load required to reduce wobbling of the components constituting the speed reducer 14 in the speed reducer housing recess 16C of the housing 16. That is, in the present embodiment, it is possible to reduce the load of the spring 32 for reducing wobbling of the components constituting the speed reducer 14 in the speed reducer housing recess 16C of the housing 16. This can reduce loss in the engaged portion and the sliding portion between the speed reducer components constituting the speed reducer 14, preventing a reduction in transmission efficiency of the speed reducer 14.

In the present embodiment, in the process of manufacturing the speed reducer-equipped motor 10, an assembling procedure can be performed in which the helical gear 20 is placed together with the eccentric shaft 22 in the speed reducer housing recess 16C of the housing 16 and then the spring 32 is inserted into the support portion 22B of the eccentric shaft 22. Thus, in the present embodiment, it is possible to prevent the spring from interfering with alignment during placement of the helical gear 20 together with the eccentric shaft 22 in the speed reducer housing recess 16C of the housing 16 as compared with a configuration in which the spring 32 is provided around the boss portion 16F of the bottom wall portion 16D of the housing 16. Furthermore, in the configuration of the present embodiment, the helical gear 20 is less inclined with respect to the housing 16 during rotation of the rotating shaft 12A of the motor 12 than in the configuration in which the spring 32 is provided around the boss portion 16F of the bottom wall portion 16D of the housing 16. This reduces deterioration in the engagement of the speed reducer components, causing less operation noise of the speed reducer-equipped motor 10.

Furthermore, the housing 16 can be thinner than in a configuration in which a space for the spring 32 is provided around the boss portion 16F of the bottom wall portion 16D of the housing 16. In the present embodiment, a portion of the housing 16 around the boss portion 16F can be reinforced by the plurality of ribs 16L. This secures the bending strength of the boss portion 16F as well as the height of the boss portion 16F in the axial direction.

In the present embodiment, the spring 32 is compressed between the surface of the disk portion 22A of the eccentric shaft 22 made of metal on the first side in the axial direction and the spring contact surface 26E of the locking gear 26 made of metal. This eliminates the need for a metal washer to be provided on the first or second side of the spring 32 in the axial direction. This can prevent an increase in the number of components constituting the speed reducer-equipped motor 10. In a configuration in which the spring 32 is compressed between a surface of the disk portion 22A of the eccentric shaft 22 made of metal on the second side in the axial direction and the bottom wall portion 16D of the housing 16 made of resin, a metal washer may need to be provided on the second side of the spring 32 in the axial direction in order to reduce wear of the bottom wall portion 16D.

In the present embodiment, the movement of the eccentric shaft 22 and the helical gear 20 toward the second side in the axial direction is limited while the disk portion 22A of the eccentric shaft 22 is in contact with the boss portion 16F of the housing 16, and the helical gear 20 is separated from the bottom wall portion 16D of the housing 16 in the axial direction while the disk portion 22A of the eccentric shaft 22 is in contact with the boss portion 16F of the housing 16. This can prevent the housing 16 and the helical gear 20 brought into contact with each other from generating a load in a boundary between the helical gear 20 and the disk portion 22A of the eccentric shaft 22. This can prevent separation of a portion of the boundary between the helical gear 20 and the disk portion 22A of the eccentric shaft 22.

In the present embodiment, a part of the spring 32 is disposed on the inner side of the recessed portion 26D of the locking gear 26 in the radial direction. This can prevent an increase in the size of the speed reducer-equipped motor 10 in the axial direction as compared with a configuration in which the inside of the recessed portion 26D of the locking gear 26 in the radial direction is solid.

In the present embodiment, an example is described in which the spring 32 is provided between the helical gear 20 and the locking gear 26; however, the present disclosure is not limited to this. The position of the spring 32 may be set as appropriate by considering, for example, the functions and shapes of the speed reducer components constituting the speed reducer 14. It is preferable to set the length of the spring 32 so that the length of the spring 32 does not exceed the set length L2 irrespective of the direction of the thrust forces F1 and F2 generated in the helical gear 20.

In the present embodiment, an example is described in which the eccentric shaft 22 is embedded in the axial center portion of the helical gear 20; however, the present disclosure is not limited to this. For example, the eccentric shaft 22 may be integrated with the helical gear 20.

In the present embodiment, an example is described in which the plurality of ribs 16L are provided around the boss portion 16F of the housing 16; however, the present disclosure is not limited to this. The selection of whether the plurality of ribs 16L are provided around the boss portion 16F may be performed as appropriate by considering, for example, the bending strength required for the boss portion 16F.

In the present embodiment, an example is described in which the spring 32 is a compression coil spring; however, the present disclosure is not limited to this. For example, an elastic member made of a polymer material such as rubber may be used instead of the spring 32. Furthermore, the elastic member may not necessarily have an annular shape.

In the present embodiment, an example is described in which the speed reducer 14 includes the locking gear 26 that stops the rotation of the output gear body 30; however, the present disclosure is not limited to this. The selection of whether the speed reducer 14 includes the locking gear 26 may be performed as appropriate by considering the rigidity of a seat cushion frame and link constituting a part of the vehicle seat.

The speed reducer 14 constituting a part of the speed reducer-equipped motor 10 described above is a speed reducer to which a planetary gear mechanism is applied. Thus, a gear whose rotation is to be limited may be selected as appropriate by considering, for example, the reduction gear ratio required for the speed reducer 14. That is, a configuration to be used may be selected as appropriate from a planetary type, a solar type, and a star type such as a 2K-H-type planetary gear mechanism and a 3K-type planetary gear mechanism by considering, for example, the reduction gear ratio required for the speed reducer 14.

An embodiment of the present disclosure has been described above; however, the present disclosure is not limited to the embodiment described above. It is needless to say that the present disclosure can be variously modified in a different manner without departing from the gist of the present disclosure.

The present disclosure has been described in accordance with an embodiment; however, it is to be understood that the present disclosure is not limited to the embodiment and structures. The present disclosure includes various modifications and variations within the equivalent range. In addition, various combinations and forms, and other combinations and forms including only one element, more, or less, are within the scope and spirit of the present disclosure.

What is claimed is:

1. A speed reducer-equipped motor comprising:
a housing to which a motor is fixed and that has a speed reducer housing portion;
a helical gear that is accommodated in the speed reducer housing portion and constitutes a first portion of a speed reducer component for reducing a rotation speed of the motor and whose tooth trace as viewed from a rotation radial direction has a helix shape in a rotation axial direction;
a second portion of the speed reducer component that is accommodated in the speed reducer housing portion; and
an elastic member that is disposed between the helical gear and the second portion of the speed reducer component and that biases the second portion of the speed reducer component toward a side opposite to the helical gear to reduce wobbling of the speed reducer component in the speed reducer housing portion.

2. The speed reducer-equipped motor according to claim 1, wherein
a part of an eccentric shaft rotated with the helical gear is embedded in an axial center portion of the helical gear, and
the elastic member has an annular shape and is disposed on an outer side of the eccentric shaft in the radial direction.

3. The speed reducer-equipped motor according to claim 2, wherein
the speed reducer component is supported by a boss portion that has a cylindrical shape and that is provided at a bottom of the speed reducer housing portion of the housing, and
the helical gear is separated from the housing while the eccentric shaft is in contact with the boss portion.

4. The speed reducer-equipped motor according to claim 3, wherein a plurality of ribs are provided around the boss portion of the housing.

5. The speed reducer-equipped motor according to claim 2, wherein
the eccentric shaft supports a locking gear that constitutes the second portion of the speed reducer component and that limits a rotation range of the motor, and
at least part of the elastic member is disposed on an inner side of the locking gear in the radial direction.
